(19) United States
(12) Patent Application Publication
(10) Pub. No.: US 2005/0076933 A1
(43) Pub. Date: Apr. 14, 2005

(54) Motorized flosser and associated method of use

(76) Inventors: William F. Getgey, Cincinnati, OH (US); Lewis Ray Dyson, Milford, OH (US); Carl R. Andry, Lawrenceburg, IN (US)

Correspondence Address: WOOD, HERRON & EVANS, LLP, 2700 CAREW TOWER, 441 VINE STREET, CINCINNATI, OH, 45202, US

(21) Appl. No.: 10/682,443

(22) Filed: Oct. 9, 2003

(51) Int. Cl. A61C 15/00

(52) U.S. Cl. 132/322

(57) ABSTRACT

A motorized flosser comprising an elongated body and a replaceable flossing head secured to an end portion of the elongated body is provided. The flossing head oscillates in a rotary or arcuate manner a length of flossing material across the surface of a user's teeth. A battery powered motor drives a drive mechanism which reciprocates in an oscillatory manner. The drive mechanism is coupled to a disk which oscillates in a arcuate or rotary motion. The disk oscillates in an arc of approximately sixty degrees. A removable and replaceable flossing head having a length of floss extending between two tines is removably coupled to the disk. Preferably, a toothpaste holder also forms a part of the flossing head.

### FIELD OF THE INVENTION

The present invention relates to dental hygiene and more particularly to a power driven instrument for flossing teeth.

### BACKGROUND OF THE INVENTION

The importance of practicing proper dental hygiene has been well documented. In this regard, it is extremely advantageous to frequently and systematically remove plaque and debris from around and between an individual's teeth. Failure to religiously remove debris and plaque from between and around teeth is likely to lead to dental disease including tooth decay, gingivitis and the like.

Conventional flossing often requires one to put his or her hands in his or her mouth. This may lead to illness due to the increased potential of the spread of bacteria. Another drawback with conventional flossing is that the used dental floss must be properly discarded in a trash receptacle or other appropriate location. Due to the flexible nature of used dental floss it is often difficult to discard the used piece of dental floss in the location the user wishes to discard it. The conventional manual method of flossing one's teeth is cumbersome due to the difficulty in maneuvering a piece of dental floss to the desired position in one's mouth. Individuals with small mouths have a particularly difficult time of flossing using the manual method. Another difficulty with conventional flossing is that it is difficult to fit the floss between teeth which are tightly squeezed together. It often requires a great deal of time, force and effort to properly locate the piece of dental floss for it to fit between two adjacent teeth. Another drawback with conventional flossing is that the gingival sulcus, the area on the gum line between teeth, commonly does not get cleaned or rubbed free of debris.

Therefore, there is a need for a flossing apparatus which is easy to use while keeping one's hands out of one's mouth, which is able to more easily fit a piece of floss between adjacent tight teeth, and which is able to clean the gingival sulcus.

Motorized toothbrushes are known. The commercial market has seen the introduction of many different types of motorized toothbrushes over the last several years. The tendency in the technology is towards more complex, expensive and non-commercially feasible methods of achieving motorized motions in the bristles and heads of toothbrushes. Related U.S. Pat. Nos. 6,000,083; 6,178,579; 6,189,693 and 6,360,395 disclose motorized toothbrushes in which batteries in the handle of the toothbrush power a motor in the handle to oscillate or rotate an elongated shaft which is connected to a circular portion of bristles in the toothbrush head. Each of these U.S. patents is fully incorporated by reference herein. The oscillation of the elongated shaft causes a circular portion of the head to which a plurality of bristles are attached to oscillate.

Motorized flossing devices are also known. For example, U.S. Pat. No. 5,411,041 discloses a motorized flosser for removing debris from between teeth and around teeth. The motorized flosser has a flossing implement detachably connected to the main body of the instrument. The flossing implement has a pair of tines between which extends a piece of floss. When activated, a motor reciprocates an output shaft which causes the flossing instrument to reciprocate. One drawback to such apparatus is that this straight reciprocal movement of the piece of dental floss does not adequately clean debris such as food particles from teeth. The piece or length of floss does not sweep across the teeth but instead only rubs against a very small area of the teeth.

It is further well known to convert a power driven toothbrush into a power driven flossing device by changing the heads on the end of a battery powered hand held instrument. For example, U.S. Pat. No. 5,762,078 discloses a detachable flosser head for a motorized toothbrush. A drive shaft in the handle assembly reciprocates causing the flosser head to reciprocate. Again this straight reciprocal movement of the piece of dental floss does not adequately clean debris such as food particles from teeth. U.S. Pat. No. 6,047,711 discloses another power driven toothbrush which may be converted to a power driven flossing device.

Another inherent drawback with known motorized flossers is that they do not adequately remove biofilm from the surface of teeth. Biofilm is a well organized community of cooperating microorganisms. One commonly known biofilm which forms on tooth surfaces is called plaque. Biofilms may be easily destroyed simply by wiping them with a brush or other mechanically abrasive material, disrupting attachment to their substrate.

Therefore, there is a need for a powered flossing apparatus which adequately removes biofilm from the surface of teeth, promotes regular flossing and is easy to use.

### SUMMARY OF THE INVENTION

The present invention comprises a motorized flosser having an elongated body having opposed first and second ends. A replaceable flosser head is removably secured to the first end of the body with a locking mechanism. A power supply is located in a hollow portion of the elongated body. The power supply energizes the flosser head when a user moves a switch located on the exterior of the body. Activation of the power supply causes a drive mechanism to oscillate the flosser head in a rotary or arcuate motion at a predetermined frequency. The frequency is preferably 2800 cycles per minute but may be any other desired frequency. This rotary oscillation of the flosser head causes a length of flossing material to rotate in an oscillatory manner through an arc. In one preferred embodiment, this arc is between 30 and 90 degrees and preferably 60 degrees.

The elongated body has a handle portion having a longitudinal axis extending therethrough and a front portion including the flosser head, the front portion being removable from the handle portion. The front portion includes a neck portion having a longitudinal axis and an end portion to which the flosser head is removably secured. The power supply includes a motor and batteries within the handle portion of the elongated body. The motor is operably connected or coupled to the flosser head for oscillating a flexible length or piece of flossing material extending between two spaced tines on the flosser head. The motor has a longitudinal axis which is coaxial with a longitudinal axis of the handle portion of the elongated body.

The handle portion further includes a simplified gear assembly. The gear assembly includes a pinion gear driven by the output shaft of the motor and a crown gear operatively coupled to the pinion gear. The output shaft of the motor rotates the pinion gear which rotates the crown gear. A link assembly including a pair of links is operatively coupled to the gear assembly in the interior of the handle portion of the body. The link assembly includes a pair of links coupled together which oscillate in an linear direction at a predetermined frequency due to the rotation of the crown gear.

The body further includes a switch to allow operation of the unit. The switch includes an actuator button and a metal contact. The switch is manually depressed by pressing a molded actuator button down and/or sliding it forwardly, from an “off” position to an “on” position. A metal contact plate is secured to the molded actuator button and once moved forward to the “on” position contacts the motor housing, completing the circuit, as in a conventional momentary switch. The motorized flosser then continuously operates until the button is slid back into an off position toward the rear end of the body and the metal contact of the switch disengages the metal motor housing, thereby interrupting the circuit.

A bite pad is secured to the first end of the elongated body. The bite pad allows a user to comfortably bite down on the end portion of the motorized flosser to more effectively force the length of flossing material between adjacent teeth.

The replaceable flosser head has a base removably connected to the first or front end of the elongated body. In one preferred embodiment of the present invention, the base includes a circular disc which is located generally in a first plane. However, other configurations of bases may be utilized in accordance with the present invention. Extending upwardly from the base of the flosser head is a yoke comprising a pair of spaced tines between which extends a piece or length of flexible flossing material, such as is known in the art.

Upon activation, the power supply of the motorized flosser oscillates a drive disk in the end portion of the body of the flosser. The drive disk rotates in an oscillatory manner about an axis which is generally perpendicular to the end portion of the body of the motorized flosser.

In one preferred embodiment of the present invention, the flosser head further comprises a flexible toothpaste holder, generally in a truncated conical shape and located between the tines of the yoke. Other configurations of toothpaste holders may be used and incorporated into the flosser head if desired. The present invention also may be used without a toothpaste holder if desired.

The tines of the yoke of the flosser head extend upwardly from the base of the flosser head and are located in a second plane. In one preferred embodiment, this second plane intersects the first plane defined by the base of the flosser head at an angle of other than 90 degrees and preferably at 77 degrees. The placement and configuration of the tines of the replaceable flosser head causes the length of flossing material extending between the tines to translate back and forth across a tooth in addition to oscillating, thereby resulting in a better cleaning action on the surface of the teeth.

In use, once the motorized flosser of the present invention is activated via the switch, the motor, gear assembly, link assembly and drive member cause the drive disk to oscillate in an arcuate or rotary manner and thereby oscillate the flossing head in the same manner. A user presses the length of flossing material between two teeth while the flossing head continues to arcuately oscillate. The rotary oscillation of the flossing head makes it easier to fit the length of flossing material between teeth which are close together or tightly fit. Once the length of flossing material is located between the teeth, the oscillation of the flossing head causes the length of flossing material to wrap around a front part of a first tooth and a rear part of a second tooth and then about the rear part of the first tooth and front part of the second tooth during each oscillation cycle. This rotary oscillation of the length of flossing material causes better cleaning of the teeth surfaces than has heretofore been possible.

If desired, one may insert toothpaste into the toothpaste holder secured to the flosser head prior to activating the motorized flosser, such that the teeth are cleaned by the toothpaste and the flossing material while simultaneously being flossed of plaque and biofilm by the oscillating flossing material.

One advantage of the present invention is that the rotary oscillating motion of the flossing head causes a length of flossing material to more easily fit between tight teeth.

Another advantage of the present invention is that toothpaste may be used to help ease the insertion of the flossing material between tight teeth. Another advantage of the present invention is that the flosser head may be quickly and easily replaced and the used flosser head discarded.

Still another advantage of the present invention is that both the front and back of adjacent teeth may be thoroughly cleaned and flossed of plaque and biofilm due to the arcuate oscillating motion of the flossing head.

### BRIEF DESCRIPTION OF THE DRAWINGS

FIG. 1 is a perspective view of the motorized flosser of the present invention;

FIG. 2 is a disassembled view of the motorized flosser of FIG. 1;

FIG. 3 is a side elevational view in cross section of the motorized flosser of FIG. 1;

FIG. 4 is top elevational view in partial cross section of the motorized flosser of FIG. 1;

FIG. 5 is top elevational view of the flossing head of the motorized flosser of FIG. 1;

FIG. 6A is a perspective view of the flossing head located in a first end position;

FIG. 6B is a perspective view of the flossing head located in a second end position;

FIG. 7 is a side elevational view of the flossing head locked in position and located in the second position; and

FIG. 8 is a perspective view of the flossing head being secured to the body of the motorized flosser.

### DETAILED DESCRIPTION OF THE INVENTION

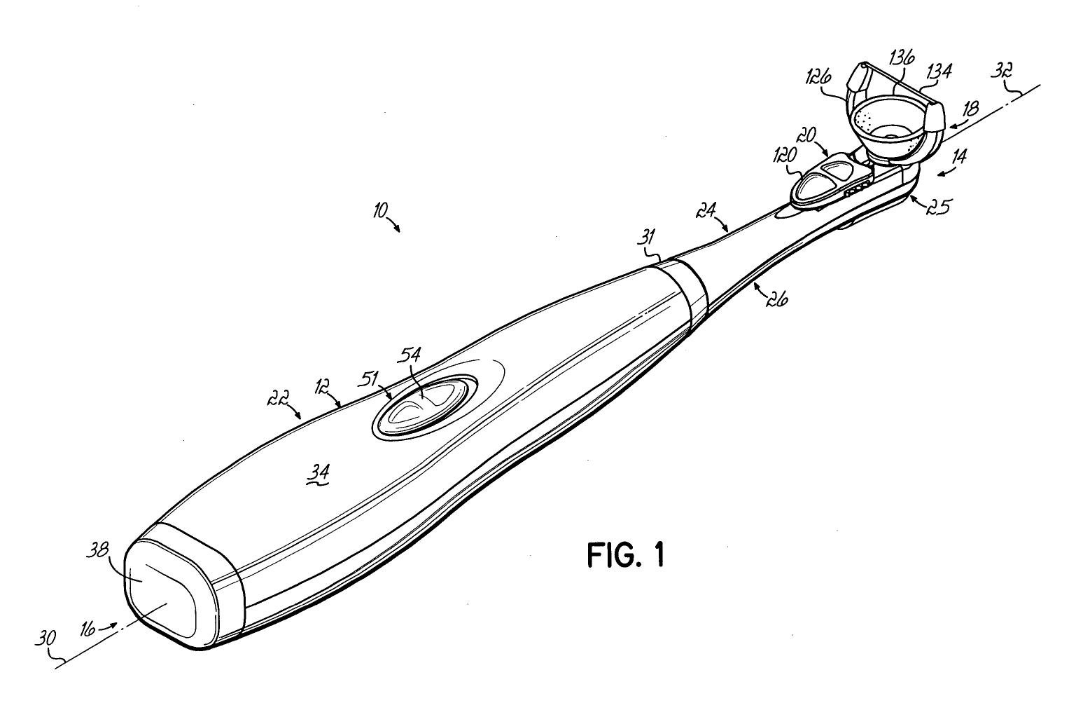

Referring to the drawings and particularly to FIG. 1, there is illustrated a motorized flosser 10 which encourages and simplifies flossing. The motorized flosser 10 comprises an elongated body 12 having a first end 14 and a second end 16 and a removable/replaceable disposable flossing head 18 which is removably secured to the first end 14 of the body 12 with a locking mechanism 20. Although one configuration of body 12 is illustrated and described, the motorized flosser 10 may be used with many different configurations or styles of bodies.

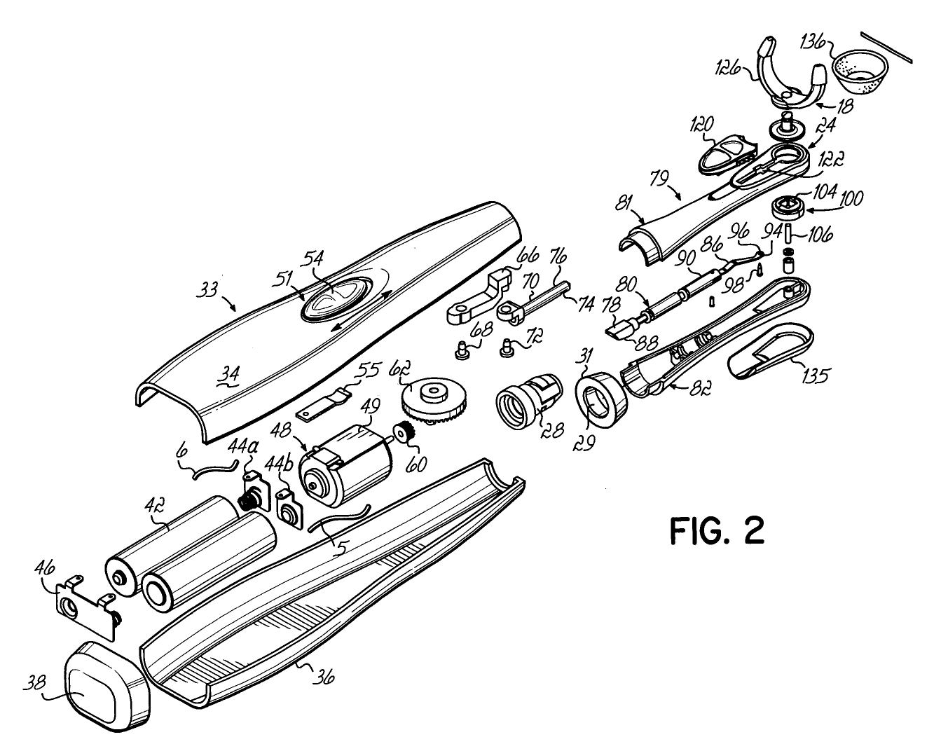

As best illustrated in FIG. 1, the body 12 comprises a handle portion 22 and a front portion 24 removable from the handle portion 22. The front portion 24 comprises an end portion 25 and an intermediate or neck portion 26 extending between the handle portion 22 and the end portion 25. Any of the portions 22, 24, 25 and/or 26 may have a hollow interior. The handle portion 22 is removably connected to the neck portion 26 via engagement of a connector 28 (shown in FIG. 2) secured to the handle portion 22 with at least one projection (not shown) on the inner surface 29 of collar 31 secured to the front portion 24 of the body 12. See FIG. 2. The connector 28 is adapted to mate with and lock together with the collar 31 secured to the front portion 24 of the body 12. The front portion 24 may be removed from the handle portion 22 by a user by grasping the front portion 24 and twisting while pulling, as is known in the art. However, the handle portion 22 may be integral with the front portion 24, if desired. As best illustrated in FIG. 1, the handle portion 22 has a longitudinal axis 30 and similarly, the neck portion 26 has a longitudinal axis 32. The longitudinal axes 30 and 32 are preferably co-linear but may be offset if desired. In accordance with the present invention, any other means of coupling the handle portion 22 and front portion 24 may be used.

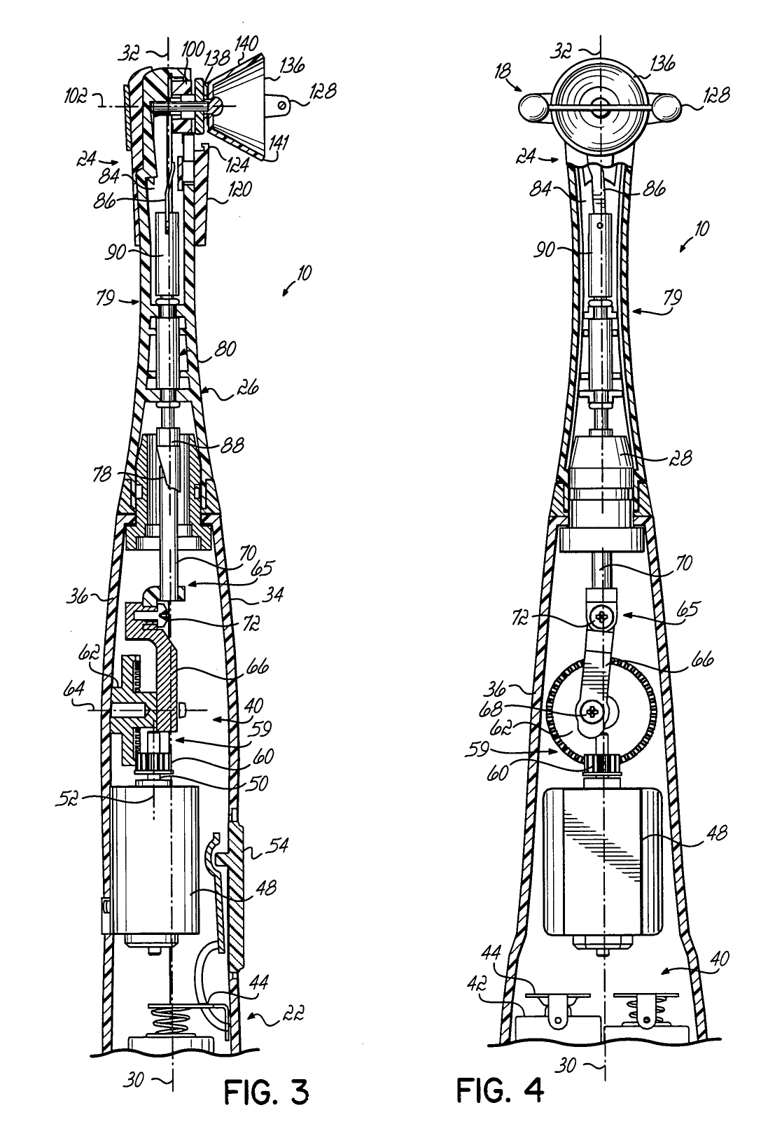

As best illustrated in FIG. 2, the handle portion 22 comprises a housing 33 comprising a front housing piece 34, a rear housing piece 36, a cap or battery door 38 which together with the connector 28, define a hollow interior 40 of the handle portion 22. See FIGS. 3 and 4. Although one configuration of handle portion 22 is illustrated and described, other configurations of handle portion may be utilized without departing from the present invention. For example, the handle portion may comprise additional pieces at different locations.

As seen in FIGS. 2, 3 and 4, inside the hollow interior 40 of the handle portion 22 is a pair of batteries 42 which are mounted between front battery terminals or contacts 44a, 44b and a common rear battery terminal or contact 46 in a known manner. The front battery terminals or contacts 44a, 44b are secured to one of the housing pieces 34, 36 of the handle portion 22 and the rear battery terminal or contact 46 is secured to the cap 38. The batteries are preferably size AA batteries, but may be any size batteries or single battery. Similarly, any other device may be used to secure at least one battery in place. To install new batteries, the battery door or cap 38 is squeezed or depressed and slid off the end of the handle portion 22. The new battery or batteries is/are then inserted and then the cap 38 is snapped back into place. The terminal ends of the batteries are then in contact with the front and rear battery terminals or contacts.

The hollow interior 40 of the handle portion 22 of the body 12 also houses a motor 48 mounted in a fixed location as shown. The motor 48 has a housing 49 and an output shaft 50 which rotates about an axis 52 when the motor 48 is activated.

As best illustrated in FIG. 2, the motor 48 is activated by the user manually moving a switch 51 including a molded button 54 and a metallic contact plate 55 secured together forwardly from an “off” position to an “on” position. When the switch 51 is in its forward “on” position, the contact plate 55 of the switch 51 presses against or contacts the metal motor housing 49 thereby completing a circuit formed by wire 5 extending between battery contact 44b and the motor housing 49 and wire 6 extending between battery contact 44a and the metallic contact plate 55. The motorized flosser 10 then operates until the switch 51 is moved rearwardly into its “off” position towards the first end of the body 12 and the metallic contact plate 55 disengages from the motor housing 49.

As best seen in FIGS. 3 and 4, rotation of the output shaft 50 of the motor 48 is operatively coupled to a gear assembly 59 including a pinion gear 60 and a crown gear 62. The pinion gear 60 is attached to the output shaft 50 of the motor 48 and is engaged with the crown gear 62. Rotation of the output shaft 50 of the motor 48 causes the pinion gear 60 to rotate about axis 52. See FIG. 3. Rotation of the pinion gear 60 causes the crown gear 62 to rotate about an axis 64 which is generally perpendicular to the axis 52 about which the pinion gear 60 rotates.

A link assembly 65 is operatively coupled or connected to the gear assembly 59. The link assembly 65 includes a first link 66 and a second link 70. The first link 66 is secured to the crown gear 62 with a fastener 68 and is offset from the axis 64 such that rotation of the crown gear 62 causes a linear oscillatory motion of the first link 66. The second link 70 is secured to link 66 with fastener 72. Link 70 passes through the connector 28 as best shown in FIGS. 3 and 4. As best illustrated in FIG. 2, second link 70 has a catch 74 at a forward end 76 thereof. The catch 74 is adapted to engage a receptacle 78 in drive member 80 when the front portion 24 of the body 12 is secured to the handle portion 22 of the body 12. This engagement of the drive member 80 located in the front portion 24 of the body 12 with the link assembly 65 of the handle portion 22 of the body 12 imparts a linear oscillatory movement from the link assembly 65 to the drive member 80, which in turns oscillates the flosser head 18 in a rotary or arcuate manner as described below.

The front portion 24 of the body 12 comprises a housing 79 having an upper housing piece 81 and a lower housing piece 82 which are coupled together to define a hollow interior 84 in which is located the drive member 80 and a link 86. The drive member 80 has a first end 88 towards which the receptacle 78 is located and a second end 90. The link 86 is secured to the drive member 80 and extends forwardly from the drive member 80. The link 86 is not linear and curved to one side. The link 86 has a forward end 94 which has a hole 96 therein through which passes a pin 98. The pin 98 secures the link 86 to a drive disk 100 which oscillates in an arcuate or rotary manner about a vertical axis 102 due to the offset position of the pin 98 relative to the axis 102.

The oscillating drive disk 100 has a receptacle 104 in the center thereof which is adapted to receive a portion of the flossing head 18 in a manner described below. Although the receptacle 104 is square in shape, it may be other configurations, if desired. A guide pin 106 is secured to the lower housing piece 82 and extends upwardly therefrom. The guide pin 106 functions to properly locate the flossing head. As best illustrated in FIG. 2, the upper housing piece 81 of the neck portion has an opening 108 therein through which the guide pin 106 extends. The guide pin 106 extends upwardly from the lower housing piece 82 of the neck portion through the receptacle 104 in the drive disk 100 and through the opening 108 in the upper housing piece 80 of the neck portion of the body. The guide pin 106 is operatively connected or coupled to the flossing head 18 in a manner described below.

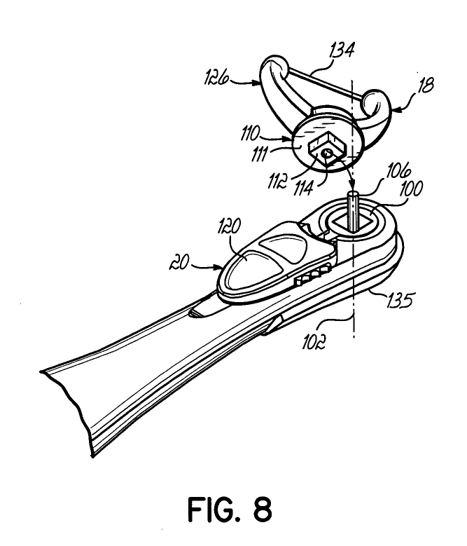

As best illustrated in FIG. 8, the flossing head 18 comprises a base 110 including a circular disk 111 and a projection 112 having a square cross sectional configuration. The projection 112 is adapted to fit snugly or tightly in the receptacle 104 of the drive disk 100. This projection 112 has a guide 114 therethrough which receives the guide pin 106. This mating/coupling between the guide pin 106 and guide 114 of the base 110 of the flossing head 18 and between the projection 112 of the base 110 of the flossing head 18 and the receptacle 104 in the drive disk 100 ensures that the flossing head 18 is correctly seated when the locking mechanism 20 is used to lock the flossing head 18 in a locked position. As shown in FIG. 7, the circular disk 111 of the base 110 of the flossing head 18 has an upwardly extending rim 116 around the periphery of the disk 111.

The locking mechanism 20 is used to lock the flossing head 18 in a locked position in which the motorized flosser 10 may be used and to unlock the flossing head 18 so that it may be separated from the body 12 of the motorized flosser 10 and replaced. The locking mechanism 20 includes a slidable locking member 120 which slides in a slot 122 in the end portion 24 of the body 12 of the flosser 10 and more particularly in the upper housing piece 91 of the neck housing 79. The locking member 120 has a locking lip 124 along the forward edge of the locking member 120, as best shown in FIGS. 3 and 7. The locking member 120 slides between a forward position (shown in dashed lines in FIG. 7) in which the locking lip 124 engages the rim of the circular disk 11 of the base 110 of the flossing head 18 and a rear position (shown in solid lines in FIG. 7) in which the locking lip 124 is behind the circular disk 11 of the base 110 of the flossing head 18. When in its forward, locking position, the locking member 120 prevents the flossing head 18 from being removed or separated from the elongated body 12 of the motorized flosser 10. When in its rear, unlocking position, the locking member 120 allows the flossing head 18 to be removed or separated from the elongated body 12 of the motorized flosser 10. Although one configuration of locking mechanism 20 is illustrated and described, other configurations of locking mechanisms may be utilized to secure the flossing head 18 to the body 22 of the motorized flosser 10 without departing from the present invention.

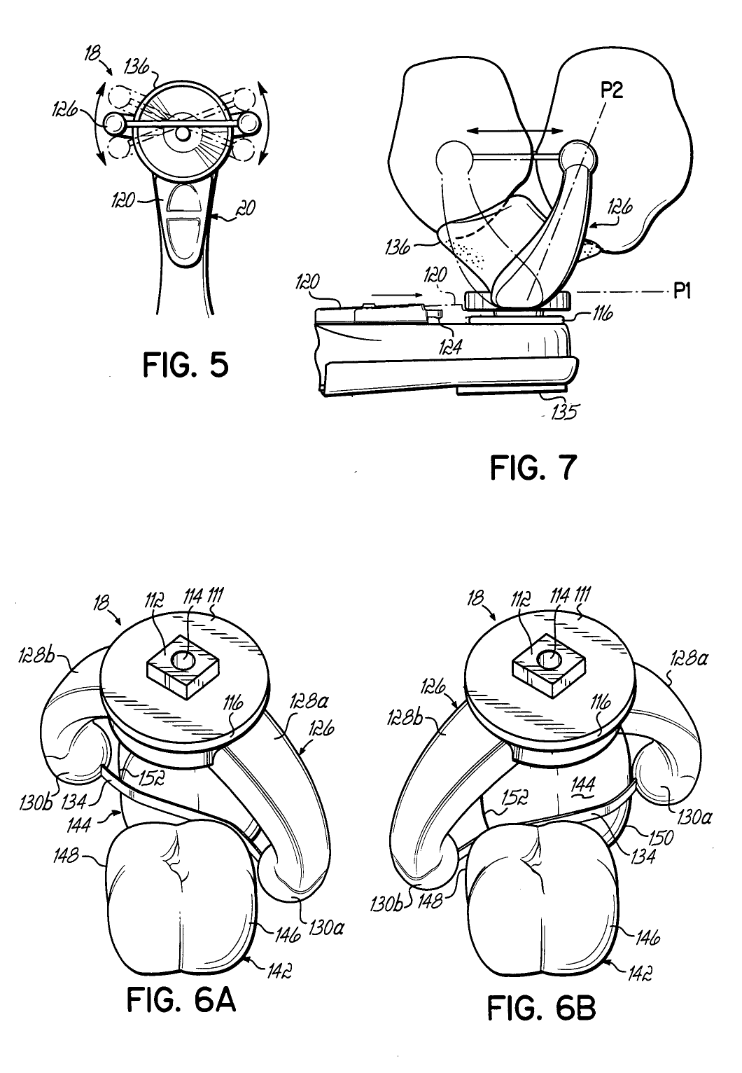

As best illustrated in FIGS. 6A and 6B, the flossing head 18 further comprises a yoke 126 having a pair of spaced tines 128a, 128b extending upwardly from the base and terminating in end portions 130a, 130b, respectively. Each of the end portions 130a, 130b has a hole (not shown) therein through which passes a length of flexible flossing material 134. The ends of the length of flossing material 134 are tied or otherwise secured to the tines 128a, 128b in any known manner. In one preferred embodiment, the ends of the flossing material are molded into the outer end portions 130a, 130b of the tines. As shown in FIGS. 5 and 7, the tines 128a, 128b are slightly curved to one side so that the length of flossing material 134 does not pass through the axis 102 about which the flosser head 18 oscillates in an arcuate manner. As shown in FIG. 5, the flosser head 18 and more particularly, the tines preferably oscillate back and forth in an arc of between 30 and 75 degrees. In one preferred embodiment, the tines preferably oscillate back and forth in an arc of 60 degrees. The offset location of the tines 128a, 128b enables the length of flossing material 134 to translate back and forth across the teeth as well as oscillate in the manner shown in FIGS. 6A and 6B. As best illustrated in FIG. 7, the tines of the flosser head define a second plane P2 which interests with the first plane P1 at an angle other than 90 degrees and preferably at about 77 degrees. Although one configuration of tine is illustrated and described, the tines of the flosser head may assume other shapes or configurations.

The speed with which the flosser head 18 rotates in an oscillatory manner may vary as desired. The flosser head 18 preferably oscillates back and forth in an arc at a frequency of between 2000 and 3000 cycles per minute. In one preferred embodiment, the tines oscillate at a frequency of 2800 cycles per minute. A cycle is defined as the movement of the tines between a first end position shown in FIG. 6A to a second end position illustrated in FIG. 6B and back to the first end position.

In one preferred embodiment, the flosser head 18 includes a cup-shaped toothpaste holder 136 having a generally truncated conical shape. As shown in FIG. 3, the toothpaste holder 136 has a bottom wall 138 and a sidewall 140 having an upper edge 141. However, other shapes and configurations may be utilized as desired. The toothpaste holder 136 is preferably made of food grade latex or polyurethane or any other soft flexible plastic material. It is also envisioned that the cup-shaped toothpaste holder could have ripple-shaped projections on the outer edge of the holder so as to enhance brushing actions during use of the flossing procedure.

As shown in FIGS. 6A and 6B, in use the length of flossing material 134 is pressed between two adjacent teeth, a first tooth 142 and a second tooth 144. The first tooth 142 has a front portion 146 and a rear portion 148. Similarly, the second tooth 144 has a front portion 150 and a rear portion 152. The length of flossing material 134 wraps around and contacts the front portion 146 of the first tooth 142 and the rear portion 152 of the second tooth 144 when the flossing head 18 is in a first end position illustrated in FIG. 6A. Similarly, The length of flossing material 134 wraps around and contacts the front portion 150 of the second tooth 144 and the rear portion 148 of the first tooth 142 when the flossing head 18 is in a second end position illustrated in FIG. 6B.

In use, an operator grabs the handle portion 22 of the motorized flosser 10 and then pushes the button 54 upwardly towards the flosser head 18. Movement of the button 54 activates the motor 48, thereby rotating the flossing head 18 in an oscillatory manner at a predetermined frequency. The user then presses the length of flossing material 134 between adjacent teeth while the flossing head 18 is oscillating arcuately. A bite pad 135 secured to the underside of the end portion 24 and more particularly to the lower housing piece 92 of the neck portion. The user may bite down on the bite pad 135 to leverage the length of flossing material 134 between the teeth. The oscillating motion moving the tines of the flosser head in an arc causes the length of flossing material to wrap around and contact a front part of a first tooth and a rear part of a second tooth adjacent the first tooth. Then as part of the same cycle, the length of flossing material is wraps around and contacts a rear part of the first tooth and a front part of the second tooth.

If desired a user may insert toothpaste (not shown) into the toothpaste holder 136 prior to using the motorized flosser 10. The toothpaste (not shown) enables the length of flossing material 134 to more easily pass between adjacent teeth and further provides additional cleaning of the teeth.

It is to be understood that various changes and modifications may be made to the preferred embodiments discussed above without departing from the scope of the present invention, which is defined by the following claims and equivalents thereof.

1. A motorized flosser comprising:
an elongated body having opposed first and second ends, and a hollow portion;
a power supply located within the hollow portion of the elongated body;
a replaceable flosser head having a base removably connected to the first end of the elongated body,
a yoke extending from the base of the flosser head having a pair of spaced tines between which extends a piece of flexible flossing material; and
said power supply being connected to the flosser head wherein upon activation, the power supply causes oscillation of the flosser head and flexible flossing material.

2. The motorized flosser of claim 1 wherein the flosser head further comprises a flexible toothpaste holder.

3. The motorized flosser of claim 2 further comprising a bite pad secured to said first end of said elongated body.

4. The motorized flosser of claim 1 wherein the power supply includes a motor and a battery.

5. The motorized flosser of claim 1 further comprising a locking mechanism for removably securing the flossing head to the body.

6. The motorized flosser of claim 5 wherein the flosser head oscillates at a frequency of 2800 cycles per minute.

7. The motorized flosser of claim 3 wherein the toothpaste holder is generally of a truncated conical shape.

8. The motorized flosser of claim 6 wherein the locking mechanism includes a slidable locking member adapted to fit over said circular disk of said base of said flosser head.

9. The motorized flosser of claim 1 wherein the flosser head oscillates at a frequency of between 2000 and 3000 cycles per minute.

10. The motorized flosser of claim 1 wherein the flosser head oscillates through an arc of between 30 and 75 degrees.

11. The motorized flosser of claim 1 wherein the flosser head oscillates through an arc of approximately 60 degrees.

12. A motorized flosser comprising:
an elongated body having opposed first and second ends, and a hollow portion;
a motor located within the hollow portion of the elongated body;
a pin extending upwardly from the first end and operatively coupled to the motor so that activation of said motor causes said pin to oscillate; and
a flosser head removably connected to the first end of the elongated body, the flosser head comprising a base having a receptacle adapted to receive said pin, a pair of spaced tines extending upwardly from the base and a piece of floss extending between the tines;
wherein activation of the motor causes the flosser head to oscillate.

13. The motorized flosser of claim 12 wherein the flosser head further comprises a toothpaste holder.

14. The motorized flosser of claim 12 wherein the toothpaste holder is plastic.

15. The motorized flosser of claim 12 wherein the hollow portion of the elongated body further includes a battery.

16. The motorized flosser of claim 12 wherein the pin defines an axis about which said flosser head oscillates.

17. The motorized flosser of claim 16 wherein the piece of floss does not pass through said axis.

18. The motorized flosser of claim 13 wherein the toothpaste holder is generally of a truncated conical shape.

19. The motorized flosser of claim 12 wherein the flosser head may be locked in place with a locking mechanism.

20. The motorized flosser of claim 12 further comprising a bite pad secured to said end portion of said body.

21. A motorized flosser comprising:
an elongated body having a handle portion, an end portion and an intermediate portion therebetween;
a drive mechanism located within the handle portion of the elongated body;
a pin extending upwardly from the end portion of the elongated body;
a flosser head removably coupled to the end portion of the elongated body, the flosser head comprising a pair of spaced tines extending upwardly from a base, a receptacle in said base adapted to receive said pin and a piece of floss extending between the tines;
wherein activation of the drive mechanism causes the pin and attached flosser head to oscillate about a vertical axis.

22. The motorized flosser of claim 21 wherein the flosser head further comprises a toothpaste holder.

23. The motorized flosser of claim 21 wherein the piece of floss of the flosser head does not intersect the vertical axis.

24. The motorized flosser of claim 21 wherein the flosser head is removably secured to said elongated body with a locking mechanism.

25. The motorized flosser of claim 21 wherein the intermediate portion of the body is removable from the handle portion of the body.

26. The motorized flosser of claim 21 further comprising a bite pad secured to said end portion of said body.

27. A flosser head for use with a motorized flosser and adapted to be oscillated about an axis after being removably secured to said motorized flosser, said flosser head comprising:
a base including a circular disk located generally in a first plane;
a pair of spaced tines extending upwardly from the base, said tines being located in a second plane, said first plane intersecting said second plane at an angle other than ninety degrees; and
a piece of flexible flossing material extending between the tines.

28. The flosser head of claim 27 wherein each of said tines has a hole through an upper portion thereof and said piece of floss passes through said holes.

29. The flosser head of claim 27 further comprising a flexible toothpaste holder secured to the base.

30. The flosser head of claim 27 further comprising a flexible toothpaste holder in a generally truncated conical shape.

31. The flosser head of claim 27 further comprising a flexible toothpaste holder located between the tines.

32. A method of flossing teeth with a motorized flosser having a flossing head including a pair of tines between which there extends a length of flossing material, said method comprising:
activating the motorized flosser so that the flossing head oscillates arcuately; and
pressing the length of flossing material between two teeth while the flossing head continues to arcuately oscillate such that the length of flossing material wraps around a front part of a first tooth and a rear part of an adjacent second tooth and then about the rear part of the first tooth and a front part of the second tooth during each arcuate oscillation cycle.

33. The method of claim 32 further comprising inserting toothpaste into a toothpaste holder secured to the flosser head prior to activating the motorized flosser such that the teeth are cleaned by the toothpaste and the flossing material while simultaneously being flossed by the oscillating flossing material.

34. The method of claim 32 wherein the tines of the flossing head and the flossing material move arcuately through an arc of approximate 60 degrees during each cycle.

35. The method of claim 32 wherein the tines of the flossing head and the flossing material move arcuately through an arc of between 30 and 75 degrees during each cycle.

36. The method of claim 32 wherein the flossing head oscillates at a frequency of between 2000 and 3000 cycles per minute.

37. A method of removing plaque and biofilm from the surface of teeth comprising:
activating an motorized flosser having a removable flossing head so that the flosser head of the motorized flosser oscillates; and
pressing a piece of floss extending between and secured to two tines of the flossing head between adjacent teeth while the flossing head continues to oscillate.

38. The method of claim 37 further comprising inserting toothpaste into a toothpaste holder secured to the flosser head prior to activating the motorized flosser.

39. A method of removing plaque and biofilm from the surface of teeth comprising:
activating an motorized flosser having a removable flossing head so that the flosser head of the motorized flosser oscillates; and
pressing a piece of floss extending between and secured to two tines of the flossing head between adjacent teeth while the flossing head continues to oscillate.

40. The method of claim 39 further comprising inserting toothpaste into a toothpaste holder secured to the flosser head prior to activating the motorized flosser.

41. A method of removing plaque and biofilm from the surface of teeth comprising:
providing an motorized flosser having a removable flossing head comprising a pair of spaced tines and a piece of floss extending therebetween,
activating the motorized flosser so that the flosser head of the motorized flosser oscillates; and
pressing the piece of floss between adjacent teeth while the flossing head continues to oscillate.

42. The method of claim 41 further comprising inserting toothpaste into a toothpaste holder secured to the flosser head prior to activating the motorized flosser.

43. A method of cleaning and flossing teeth so as to remove plaque and biofilm from the surface of the teeth, which method comprises:
inserting flossing material having toothpaste applied thereto between the teeth; and
simultaneously oscillating the flossing material and moving the flossing material vertically between the teeth.

44. The method of claim 43 such that the length of flossing material wraps around a front part of a first tooth and a rear part of a second tooth adjacent the first tooth and then about the rear part of the first tooth and a front part of the second tooth during each arcuate oscillation cycle.

45. The method of claim 43 wherein the flossing material oscillates at a frequency of between 2000 and 3000 cycles per minute.

46. The method of claim 43 wherein the flossing head oscillates at a frequency of approximately 2800 cycles per minute.

47. A method of removing biofilm from teeth which comprises:
oscillating a length of flossing material;
applying toothpaste to the length of material; and
moving the length of flossing material vertically between the teeth while continuing the oscillation of the length of flossing material having toothpaste applied thereto.
